(19) United States
(12) Patent Application Publication
(10) Pub. No.: US 2018/0293670 A1
(43) Pub. Date: Oct. 11, 2018

(54) ARCHITECTURE OF SOCIAL NETWORKING QUESTION AND ANSWER PLATFORM BASED ON BLOCKCHAIN

(71) Applicant: Yi Fan Yin, Vancouver (CA)

(72) Inventor: Yi Fan Yin, Vancouver (CA)

(21) Appl. No.: 15/949,063

(22) Filed: Apr. 9, 2018

Related U.S. Application Data
(60) Provisional application No. 62/483,408, filed on Apr. 9, 2017.

(51) Int. Cl. G06Q 50/00; G06Q 30/02; G06Q 20/38; H04L 29/06

(52) U.S. Cl. CPC G06Q 50/01; H04L 63/083; G06Q 20/382; G06Q 30/0233

(57) ABSTRACT

The invention discloses an architecture of the social question and answer platform based on a block chain, comprising a social networking Q&A website basic unit, a user interface unit, a user incentive unit, a first smart contract formation unit and a first smart contract execution unit. The user interface unit includes a registration and login module for inputting a user ID, an identity verification module to discover whether the user ID is real or fake, a user level rating module, a permission setting module, an fund record module for storing the information of the adaptation fund, and a mapping table for storing the user's identity information and getting the relationship between the user ID and the user's identity information. The present invention defines the privilege and obligations of the users on the Q&A websites. The users need to be responsible for their answer contents and enjoy the copyright benefit brought by their answer contents.

### CROSS-REFERENCE TO RELATED APPLICATION

This application claims the benefit of the earlier filing date of U.S. Provisional Application No. 62/483,408, filed Apr. 9, 2017.

### FIELD OF THE INVENTION

The present invention relates to the field of internet application technologies, and more particularly, to an architecture of a social networking question and answer platform based on blockchain and a construction method thereof.

### BACKGROUND OF THE INVENTION

The current social question and answer (Q&A) websites are very popular for users from all walks of life. The users share their knowledge, experience and insights. The most famous large-scale social Q&A websites are Quora in the United States and Zhihu in China. With nearly 100 million registered users and almost 30 million daily active users, the Zhihu has more than one-hour daily visit time per capita, and its monthly page views exceed 20 billion.

Please refer to FIG. 1. FIG. 1 is a schematic diagram an architecture of a social networking Q&A website in the prior art. As shown in the figure, the social networking Q&A website usually includes a user interface unit, a social networking Q&A website basic unit, a reply sorting unit, and a reply awarding unit.

With the continuous opening and the increase in the number of users, the potential problem that the Quora in the United States will face is how to ensure that the quality of questions and answers do not decline, and how to make the Q&A website product healthy, stable, and sustainable. The Zhihu in China also have the same problems the Quora is currently facing. Specifically, the problems are summarized in the following:

1. Unregulated User Registration System

The social networking websites in the prior art for everyone do not adopt strict registration methods such as real-name system authentication to restrict users. The user interface unit in FIG. 1 is directly connected to the social networking Q&A website basic unit without any identity establishing mechanism.

At the beginning, the initially user registration for the Zhihu is by invitation only, however, it becomes open registration after one year of operation. The Users could use their real name or made up names. In theory, multiple user accounts can be registered by one person. There is no rating system. There is no trust establishment mechanism for identity. This would bring catastrophic problems to the management of large-scale social Q&A websites in the prior art because on one is responsible for the information post. For example, it is difficult to limit the spread a large amount of fake or junk information on the website platform.

2. No Assessment Mechanisms for the Information Post

To motivate users to contribute their own knowledge, the reply sorting unit in the social networking website is using to amount the user's upvotes for sorting the information post (such as in FIG. 1). The biggest problem with this sorting mechanisms is: on the one hand the users feel burden when screening and identifying information they needed and are difficult to find the answer contents of high quality; on the other hand, the enthusiasm of the elite users who could answer questions with high quality will greatly been hurt by the unfair sorting mechanisms.

3. No Strategic for the Knowledge/IP Commercialization & Monetization

The Q&A websites in the prior art does not have a guidance on the knowledge/IP monetization. The user can only monetize from the advertiser according to their fame in the social networking platform. As a result, many users who can provide high quality answers are lost and the user's loyalty is reduced.

In addition, some Q&A websites introduced some business models (such as the reply quotation unit) that monetized the knowledge since last year. The business model is paying someone to ask him/her a question and obtain answer from him/her. However, in this mode, the user who asked a question has to pay the user who answering the question, no matter the quality of the answers. This is a business model that does not conform to laws of economics.

4. No Intellectual Property Right Protection Mechanism

As a knowledge-sharing community, the Q&A websites has a lot of answers written by its users, the copyright issue of the answers will surely become more and more serious. At present, the users could only hire third-party lawyers to protect their IP privilege, the cost is not only high, but also the results of IP privilege protection do not affect the reputation of the defendant on the Q&A websites.

From the above points, if there is no intellectual property operation concept to maintain the social networking Q&A websites, the result obtained will be difficult to make the Q&A website products healthy, stable and sustainable.

### BRIEF SUMMARY OF THE DISCLOSURE

The purpose of the present invention is to overcome the above-mentioned deficiencies in the prior art, provide an architecture of a social networking question and answer (Q&A) platform based on blockchain, and the technical scheme of the present invention is as follows:

The architecture of a social networking question and answer (Q&A) platform based on blockchain includes a social networking Q&A website basic unit, a user interface unit, a user incentive unit, a first smart contract forming unit and a first smart contract execution unit.

The social networking Q&A website basic unit is a component for presenting question contents and answer contents post by users; wherein the user to post question contents is question user; the user to post answer contents is responding user.

The user interface unit, connected to the social networking Q&A website basic unit through the network, and includes a registration and login module for inputting a user ID, an identity verification module to discover whether the user ID is real or fake, a user level rating module, a permission setting module, an fund record module for storing the information of the adaptation fund, and a mapping table for storing the user's identity information and getting the relationship between the user ID and the user's identity information; the user level rating module determines the user's corresponding hierarchy and establishes a corresponding reward account according to the user's identity information, the information of the adaptation fund and the information of the relationship between the user ID and the user's identity information.

Wherein, the user's identity information corresponding the user ID includes at least an education record, a paper publication record, a certificate of title, and/or a certificate of practice; the permission setting module set up the basic user level information of the basic user level according to the user's corresponding hierarchy; and the temporary user level is purchased by the reward account, the basic user level and the temporary determine a user level; and the user level determines the user's browsing privilege, the pageview quota, the user's upvote privilege and the upvote quota according to the basic user level; the users which the user level is lower than or equal to the user level of the user are only permitted browse/access Q&A contents.

The user incentive unit has a collecting module, the collecting module transforms the valid reply amount collected from other users to money or tokens and deposited them in the reward account by the fund record module; wherein the valid reply amount is the valid thumbs up amount multiplied by a royalty factor of corresponding the user level of the responding user, wherein the valid user thumbs up amount is collected from other users who has a higher than or equal to the user level of the user who is answering the question, and the royalty factor of the user level is positively related to the user level of the responding users.

The first smart contract forming unit issues a smart contract request and content according to a user's instruction; and a first smart contract execution unit receives the smart contract request and content, and according to the user issued smart contract content, completes the agreed terms in the smart contract content using the funds in corresponding reward account of the user.

Preferably, the amount of the user's browsing privilege in a time interval is limited, that is, within each time interval, the amount of the user's browsing privilege is N and is not accumulated in the next time period; and/or the amount of the user's upvote privilege for each user in a time interval is limited, that is, within each time interval, the amount of the user's thumbs up is M and is not accumulated in the next time period; wherein N and M are positive integer.

Preferably, the agreed terms in the smart contract content is to increase the user's pageview quota and/or the user's upvote quota by using funds and/or points from the user's reward account the first smart contract forming unit uses the funds and/or points in the user's corresponding reward account to complete the agreed terms of the smart contract content.

Preferably, the user incentive unit also includes an upgrade module; when the valid thumbs up amount collected from other users reaches a predetermined threshold, the upgrade module instructs the first smart contract forming unit to issue a smart contract request and content to encourage the responding user, the first smart contract execution unit receives and sands the smart contract to a level adjustment unit, the level adjustment unit rises the royalty factor of the user level provisionally by rising the basic user level.

Preferably, the architecture further comprises a privilege self-tuning unit that allows the responding user to adjust the level of the post answer contents to be lower or higher than the user level of the responding user, and the royalty factor of the responding user is also reduced or raised to the corresponding level after the response level is reduced or raised provisionally.

Preferably, the architecture further comprises a user level adjustment unit, the agreed terms in the smart contract content of the first smart contract forming unit is to increase the user level issued by the user interface unit temporarily using the money or tokens deposited in the reward account and executed by the first smart contract execution unit and the user level adjustment unit to adjusts the temporary user level.

Preferably, the agreed terms in the smart contract content of the first smart contract forming unit is to cash out all or part of the tokens from the user's reward account.

Preferably, the architecture further comprises at least one affiliate linking website and a charging for translation unit, the agreed terms in the smart contract content of the first smart contract forming unit is to pay the service fee for the users by using the money or tokens deposited in the reward account and executed by the first smart contract execution unit and the charging for translation unit.

Preferably, the architecture further comprises a content component timestamp unit that uses the blockchain mode to record the question contents and the answer contents presented by the social networking Q&A website basic unit, wherein each record of the question contents and the answer contents at least includes a timestamp.

Preferably, the architecture further comprises an IP protection unit, the IP protection unit receives a user's judicial relief request for an answer content with the timestamp recorded by the content component timestamp unit, and uses the crawler technique to compare the similarities extracting of the answer content with the other answer contents post on the social networking Q&A website, and then compares the timestamp of the answer content with that of the other answer contents to get a judgment result if at least one similarities answer has been found, the judgment result will be sent to a result feedback unit.

Preferably, the architecture further comprises a second smart contract forming unit and the second smart contract execution unit, if the infringing result is true, the second smart contract forming unit issues a infringing result information from the result feedback unit, forms a smart contract content to punishment the infringing user, and the second smart contract execution unit receives and sands the smart contract to a level adjustment unit, the level adjustment unit brings down the user level of the infringing user.

As can be seen from the above technical solution, the present invention is different from the beneficial effects brought by the prior art solution as follows:

1. User Registration System

The user registration system of the social Q&A websites could be adopted by the present invention is a certificate document/ID card with the real name and/or be invitation-only community that provides members with rules of the rating and insider access.

2. Assessment Mechanisms for the Information Post

The user interface unit have user logic that authorizes users to perform an operation not only on posting question/answer contents, but also on sorting and assessing question/answer contents according to the user level of the users. In other words, to ensure that the praise is reasonable, the answer contents should be judged by the users whose user level are equal or higher than to the user level of the answer user.

3. Strategic for the Knowledge/IP Commercialization & Monetization

The user incentive unit of the present invention is focusing on the value enhancement and monetization of user's IP property through an IP commercialization process according to correcting the amount of the reasonable praise and providing strategic guidance for the users who is answering the question. In other words, the user incentive unit of the present invention helps the users who is answering the question derive returns on their intellectual property portfolios through commercializing and then managing their intellectual assets.

4. Intellectual Property Right Protection Mechanism

As a knowledge-sharing community, not only does it respond to users' IP right protection requirements through a dedicated mechanism using the blockchain mode to the answer contents with the receive timestamp, and comparing the similarities extracting of the answer content with the other answer contents to get a judgment result, but also the judgment results affect the reputation of the defendant on the Q&A websites.

Therefore, the present invention defines the privilege and obligations of the users on the Q&A websites. The users need to be responsible for their answer contents and enjoy the copyright benefit brought by their answer contents.

### BRIEF DESCRIPTION OF THE DRAWINGS

FIG. 1 is a schematic diagram of a social networking question and answer platform in the prior art;

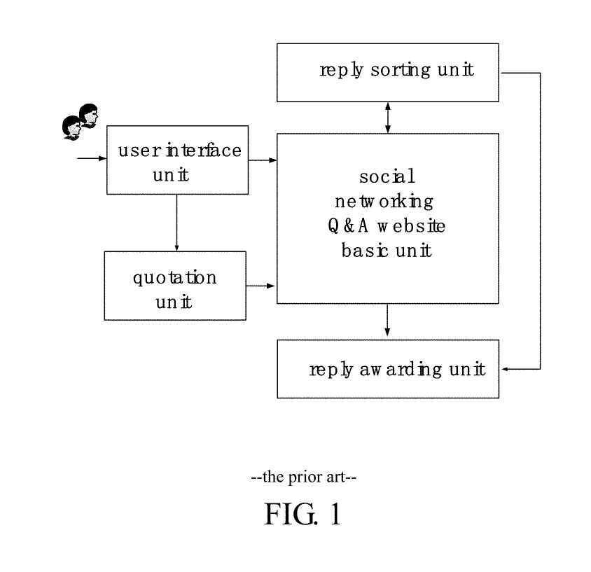

FIG. 2 is a schematic diagram of a social networking question and answer platform based on blockchain according to the present invention;

### DETAILED DESCRIPTION OF THE EMBODIMENTS

The specific embodiments of the present invention will be further described in detail below with reference to the accompanying drawings.

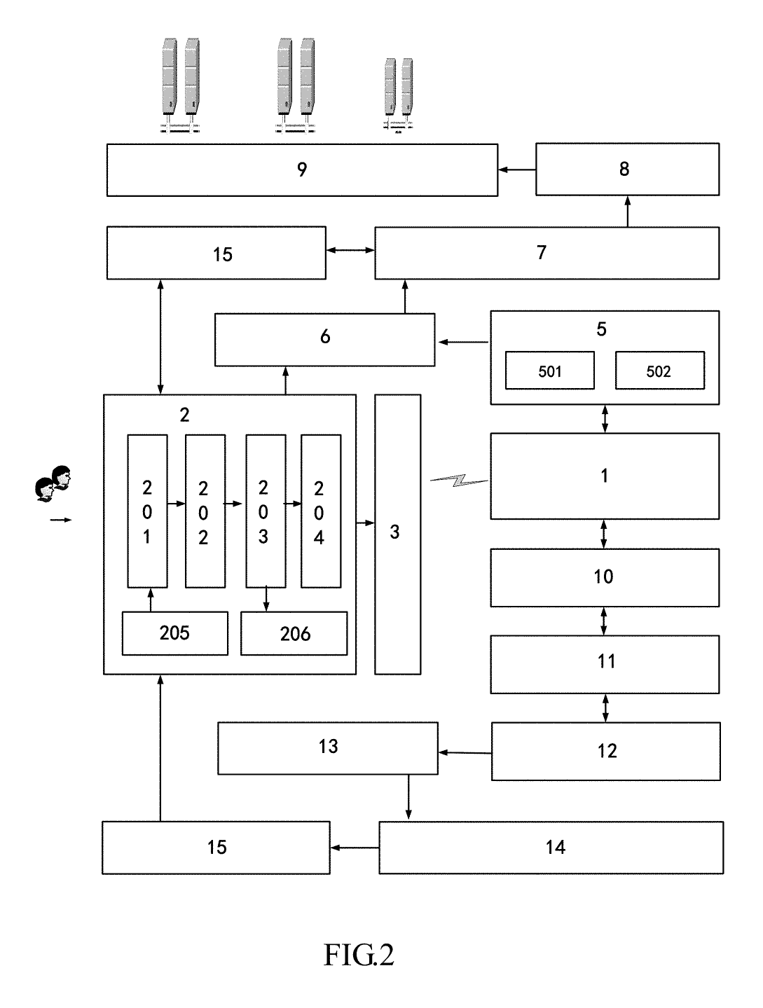

Please refer to FIG. 2. FIG. 2 is a schematic diagram of an architecture of a social networking question and answer platform based on blockchain of the present invention. As shown in FIG. 2, it includes a social networking Q&A website basic unit 1, a user interface unit 2, a user incentive unit 5, a first smart contract formation unit 6, and a first smart contract execution unit 7.

It should be noted that any component that presents user's question and answer content in the embodiment of the present invention, that is, the social networking Q&A website basic unit 1, may include all the components of the platforms of the Q&A websites in the prior art, such as search and statistics functions.

In the embodiments of the present invention, the user interface unit 2 is the cornerstone for establishing the structure of the social networking Q&A website based on the blockchain of the present invention and are important ties for the knowledge/IP commercialization & monetization. The user interface unit 2 is connected to the social networking Q&A website basic unit 1 through the network, specifically includes a registration and login module 201 for inputting a user ID, an identity verification module 202 to discover whether the user ID is real or fake, a user level rating module 203, a permission setting module 204, an fund record module 205 for storing the information of the adaptation fund, and a mapping table 206 for storing the user's identity information and the user's identity information and getting the relationship between the user ID.

Unlike other registration and login modules, at the time of initial registration, the user needs to input user's identity information from client port by the registration and login module 201. In addition to an identity, the identity information also includes other information can be used to establish the user's corresponding hierarchy.

Wherein, the user's identity information corresponding the user ID includes at least an education record, a paper publication record, a certificate of title, and/or a certificate of practice. The education record may include a degree certificate, a student ID, and a school transcript. Certificates of practice may include certificates such as lawyers' qualifications, CPAs, CFAs and so on.

Since the platforms of the Q&A website adopt a real-name system, the identity verification module 202 may authenticate one or more identity information after receiving. In other words, the identity verification module 202 needs to discover whether the user ID is real or fake when a user first login, and identity verification module 202 may only verify one of the information at the beginning and the verification of other information can be performed later, or verify multiple information at once, or even all of them.

In the preferred embodiment of the present invention, the student ID may be directly uploaded for real-name registration. The student ID is easy to discover which is real or fake, for example, the authenticity of the student ID can be verified through the relationship with other student users from the same school or through the referral and invitation between the students. If one of the users is found to be false, then all the accounts that he introduced can be removed. Thus, the credibility of the users on the platform of the Q&A websites will increase and can also improve the purity of the academic value of the platform.

The user level rating module 203 determines the user's corresponding hierarchy and establishes a corresponding reward account according to the user's identity information, the information of the adaptation fund and the information of the relationship between the user ID and the user's identity information.

The permission setting module 204 set up the basic user level information of the basic user level according to the user's corresponding hierarchy; and the temporary user level is purchased by the reward account, the basic user level and the temporary determine a user level.

In other words, the user level is divided into a basic user level and a temporary user level, and the basic user level is determined by the mapping table 206.

The basic user level of each user is usually determined by the sum of total value of the education record, the paper publication record, the certificate of title, the certificate of practice and the like. After obtaining all the identity information from a user, the user's basic user level can be determined through the mapping relationship table 206 for basic user level.

The term content in the mapping table 206 for basic user level includes personal identity information and its corresponding level rating, each piece of the personal identity information has a corresponding level rating, the personal identity information could include the comprehensive ranking of the school, the academic record of the student, the number of articles published, the ranking of the published publication, and another level rating factors such as whether there is a practice certificate and a title. The sum of each personal identity information is used to determine the user's basic user level. For example, if a user is a student from Harvard University, then Harvard's undergraduate level can be rate as level 50, Harvard's master's degree can be rate as level 70, and Harvard's doctoral degree can be rate as level 85.

In addition, the mapping relationship table for basic user level may also dynamically change during use. In the present invention, each schools or groups may have a Key Performance Indicators (KPI) assessment. Contributions of a school and group could be used to adjust the rating of the school or group in the mapping relationship table of the uses for basic user level. For example, the more rewards the students have received in Tsinghua University over time, the higher the KPI of the entire school, then the starting level of all Tsinghua students in the mapping relationship table for basic user level are increased, for example, from level 50 to level 51. Each student benefits from it and inspires the user's collective sense of honor.

After completing the determination of the user's basic user level, it is also necessary to establish a corresponding reward account for the user. Any payment made by the user during the use of the social networking question and answer platform can be withdrawn from and the loyalties received can be credited to the reward account. Of course, the user's contribution fund information can also be credited to the reward account. Reward accounts can be either in cash or in the form of tokens, but in any case, they can be converted to each other and traded in the form of smart contracts.

The temporary user level of the users can be improved in the following two ways:

One way is to pay a certain amount of fees from the reward account, and the temporary user level can be increased. The temporary user level's promotion can be permanent, or it can be only last a period. For example, a user pays $100 for adding 3 levels for one-month period. After one month, the user returns to his original temporary user level. Or, if that the user pays $100, the temporary user level is permanently increased by 1 level.

Another way can be taken is: pay a certain amount of reward points from the reward account, the user's temporary user level can be improved. The temporary user level promotion can be permanent, or it can be last only for a period. For example, a user pays 1000 points for adding 3 levels for a month, and one month later, the user returns to his original user level. Or, the user pays 1000 points and its temporary user level permanently increases by 1 level. wherein, the reward points can be obtained by the contribution degree of the user's answers and papers published in the networking question and answer platform, which will be described in detail later.

Each user's user level corresponds to a set of user privilege. This set of privilege usually includes a user question permission, a user responding permission, a user pageview permission, a pageview quota, a user upvote permission and a upvote quota. The higher the user level, the fewer barriers to using the networking question and answer platform, and vice versa.

The user's question permission may open to all registered users, and the user who asked the question can see the answer contents post by users from all user level.

However, other users' pageview privilege and user's upvote (thumb up) privilege are directly linked to the user's user level. the user level determines the user's browsing privilege and the user's upvote privilege according to the basic user level; the users which the user level is lower than or equal to the user level of the user are only permitted browse/access Q&A content.

As shown in FIG. 2, the permission setting module 204 may determine the user's pageview permission and the user's upvote permission according to the user level. The pageview privilege of the user can only permit users browse the contents of the question and/or answer that is lower than or equal to the user's user level. The amount of valid user upvotes are collected from other users that are higher than or equal to the user's user level. Each user can only see responses from users who has the same or lower user level. That is to say, each post can only be reviewed by a user who has the same or higher level than the user who posted the reply/answer. If a post is upvoted by a user with a higher or equal user level than the user who posted the answer, then the amount of these contributions is paid to the user as royalty reward, which will be described in detail later.

The pageview quota for each user in a time interval is limited, that is, within each preset time period, the number of pages/answers a user can view is N, and is not accumulated in the next time period, and/or upvote quota for each user in a time interval is limited, that is, within each preset time period, the number of upvotes a user can give out is M, and is not accumulated in the next time period, wherein N and M are positive integer and the positive integers, N and M can be equal or different.

Specifically, each user on the networking question and answer platform will have a certain amount of pageviews (the pageview quota) and a certain amount of upvotes (the upvote quota) can give to those posts/answers per day based on the user's user level. The pageview quota and the upvotes quota will need to be used in one day, and the next day will be cleared and reset. If the user wants to read more posts or upvote more the answers beyond the quota in a day, it can be achieved by purchasing the more pageview quota and the more upvote quota.

After browsing a post/answer, if the user like it, the user can give a upvote to the post/answer, the upvotes accumulated can be transformed to royalties and be given to the original author (the responding user). If a user spends a upvote quota, the user has the right to visit the post again later. If the post's author has any updates or subsequent changes, the user upvoted this post before may view the same post again at any time. If no upvote was given at the time of browsing, the user had to spend one of the another pageview quota to browse the post again.

In an embodiment of the present invention, the user incentive unit 5 includes a collecting module 501, the collecting module 501 transforms the valid reply amount collected from other users to money or tokens and deposited them in the reward account by the fund record module 205. Wherein, the valid reply amount is the valid thumbs up amount multiplied by a royalty factor of corresponding the user level of the responding user, wherein the valid user thumbs up amount is collected from other users who has a higher than or equal to the user level of the user who is answering the question, and the royalty factor of the user level is positively related to the user level of the responding users.

Moreover, the user incentive unit 5 may also include an upgrade module 502, when the valid thumbs up amount collected from other users reaches a predetermined threshold, the upgrade module 502 instructs the first smart contract forming unit 6 to issue a smart contract request and content to encourage the responding user, the first smart contract execution unit 7 receives and sands the smart contract to a level adjustment unit 15, the level adjustment unit 15 rises the royalty factor of the user level provisionally by rising the basic user level. Of course, after the increase in the basic user level provisionally, the royalty factor will increase accordingly.

For example, since each browsing user can only see the post answer from the responding user whose user level is the same as or lower than that of the browsing user. For example, if a responding user and a browsing user are in the same hierarchy (both are level 70), when the responding user has just posted an answer, the answer can be seen by the browsing user who has the same user level (70). But as the amount of the upvotes received is increased and reaches a predetermined threshold, the basic user level of the responding user will rise to level 71 provisionally issued by the upgrade module 502. At that moment, the browsing user's basic user level has not changed, is still at level 70. The browsing user (level 70) who is not able to browse the post anymore.

Specifically, if the browsing user (level 70) views an answer and does not upvote for the answer, the browsing user can not view it again after the basic user level of the responding user raised to level 71 provisionally. However, the browsing user (level 70) views an answer and upvoted for the answer, the browsing user can view it again after the basic user level of the responding user raised to level 71 provisionally. Of course, the browsing user can review it anytime later if the user level of the browsing user is higher than that of the basic user level of the responding user raised provisionally.

In other situations, if there is no upvote is given, the browsing users (at level 70) can pay for money or tokens deposited in the reward account to rise the temporary user level to level 71. That is, in some embodiments of the present invention, the term formed by the first smart contract forming unit 6 is for an increment in user temporary user level issued by the user interface unit 2, and the user's temporary user level increment is performed by the first smart contract execution unit 7 and a user level adjustment unit 15.

Therefore, the present invention not only encourages the responding users to public high-quality answer, but also encourages the browser users to frequently open the websites and apps to view newly-created posts of their favorite users. If the browsing user likes the post answer, upvote it early. To summarize, in general, the post level is the same as the user's user level in the beginning, the post level can rise higher than user level of the responding user after the answer received more and more upvote. If the post level is higher, the royalty factor is also increased to the corresponding level, the rewords the responding user received is higher.

In a preferred embodiment of the present invention, it may further include a privilege self-tuning unit 3 that allows the responding user to adjust the level of the post answer contents to be lower or higher than the user level of the responding user, and the royalty factor of the responding user is also reduced or raised to the corresponding level after the response level is reduced or raised provisionally. It should be noted that if the responding user uses the privilege to self-adjusting post level lower or higher than their user level, the royalty factor is fixed at the post level that is adjusted downwards or upwards.

In other words, the responding user may decide that the post is maintained at a higher level, this choice may bring him a higher level of royalties, or it may also reduce the post level of the post, so that more users can view and upvote the post.

In some embodiments of the invention, the amount of user's pageview quota and/or user's upvote quota can be increased by using funds and/or points from the user's reward account.

As shown in FIG. 2, the first smart contract forming unit 6 forms a smart contract that increases a user's pageview quota and/or a user's upvote quota according to an instruction issued by the user interface unit 2 and issues an execution request; the first smart contract execution unit 7 receives and executes the smart contract. According to the contents of the smart contract issued by the user, the first smart contract execution unit 7 uses the funds and/or points in the user's corresponding reward account to complete the agreed terms of the smart contract content.

In some embodiments of the present invention, the first smart contract forming unit 6 forms a smart contract that converts all or part of the tokens in the reward account into fund/cash according to the user's instruction; and the first smart contract execution unit 7 receives and complete the agreed terms of the smart contract.

In some preferred embodiments of the present invention, at least one affiliate link website 9 may also be included in the social networking question and answer platform, for example, a patent search website, etc. If the patent search website is also a paid browsing website, the first smart contract formation unit 6 would form the agreed terms in the smart contract content to pay the service fee for the users by using the money or tokens deposited in the reward account and executed by the first smart contract execution unit 7 and the charging for translation unit 8.

In addition, the social networking question and answer platform of the present invention further includes a content component timestamp unit 10, a IP protection unit 11, a result feedback unit 12, a second smart contract formation unit 13, and a second smart contract execution unit 14. The content component timestamp unit 10 uses the blockchain technology to record the contents of the user question and answer presented by the social networking Q&A website basic unit 1. This time stamp can be used as a time evidence of copyright authorities.

In addition, the IP protection unit 11 receives a user's judicial relief request for an answer content with the timestamp recorded by the content component timestamp unit 10, and uses the crawler technique to compare the similarities extracting of the answer content with the other answer contents post on the basic unit of social networking Q&A website, and then compares the timestamp of the answer content with that of the other answer contents to get a judgment result if at least one similarities answer has been found, the judgment result will be sent to a result feedback unit 12.

In other words, the use of blockchain technology can provide a reliable timestamp. Any answer posted on the social networking Q&A website basic unit 1 has a multiparty-recognized posting time. The feasibility of the collected electronic evidence chain is greatly improved. The time cost for evidence collection on blockchain is almost zero.

Of course, the timestamp of the blockchain does not guarantee that the posts made by all users are original, but it can record the posting time of a post on the social networking Q&A website basic unit 1. Therefore, as a platform, it is not always necessary to check all user's content distributed on the platform is original, but if someone reports an infringement, it is easy to check and can be handled directly after verification, for example, deleting infringing posts. Moreover, the second smart contract formation unit 13 may also issue the infringing result information according to the privilege protection feedback unit 12 to form a smart contract content to punishment the infringing user; the second smart contract execution unit 14 and sands the smart contract to a level adjustment unit 15, the level adjustment unit 15 brings down the user level of the infringing user.

While this invention has been particularly shown and described with references to preferred embodiments thereof. This invention may, however, be embodied in different forms and should not be construed as limited to the embodiments set forth herein. It will be understood by those skilled in the art that various changes in form and details may be made herein without departing from the spirit and scope of the invention as defined by the appended claims.

1. A architecture of the social networking Q&A platform based on blockchain, comprising:
a social networking Q&A website basic unit (1), which is a component for presenting question contents and answer contents post by users; wherein the user to post question contents is question user; the user to post answer contents is responding user;
a user interface unit (2), connected to the social networking Q&A website basic unit (1) through the network, and includes a registration and login module (201) for inputting a user ID, an identity verification module (202) to discover whether the user ID is real or fake, a user level rating module (203), a permission setting module (204), an fund record module (205) for storing the information of the adaptation fund, and a mapping table (206) for storing the user's identity information and getting the relationship between the user ID and the user's identity information; the user level rating module (203) determines the user's corresponding hierarchy and establishes a corresponding reward account according to the user's identity information, the information of the adaptation fund and the information of the relationship between the user ID and the user's identity information;
Wherein, the user's identity information corresponding the user ID includes at least an education record, a paper publication record, a certificate of title, and/or a certificate of practice; the permission setting module (204) set up the basic user level information of the basic user level according to the user's corresponding hierarchy; and the temporary user level is purchased by the reward account, the basic user level and the temporary determine a user level; and the user level determines the user's browsing privilege, the pageview quota, the user's upvote privilege and the upvote quota according to the basic user level; the users which the user level is lower than or equal to the user level of the user are only permitted browse/access Q&A contents;
the user incentive unit (5), having a collecting module (501), the collecting module (501) transforms the valid reply amount collected from other users to money or tokens and deposited them in the reward account by the fund record module (205); wherein the valid reply amount is the valid thumbs up amount multiplied by a royalty factor of corresponding the user level of the responding user, wherein the valid user thumbs up amount is collected from other users who has a higher than or equal to the user level of the user who is answering the question, and the royalty factor of the user level is positively related to the user level of the responding users;
a first smart contract forming unit (6), which issues a smart contract request and content according to a user's instruction; and
a first smart contract execution unit (7), which receives the smart contract request and content, and according to the user issued smart contract content, completes the agreed terms in the smart contract content using the funds in corresponding reward account of the user.

2. The architecture according to claim 1, wherein the amount of the user's browsing privilege in a time interval is limited, that is, within each time interval, the amount of the user's browsing privilege is N and is not accumulated in the next time period; and/or the amount of the user's upvote privilege for each user in a time interval is limited, that is, within each time interval, the amount of the user's thumbs up is M and is not accumulated in the next time period; wherein N and M are positive integer.

3. The architecture according to claim 2, wherein the agreed terms in the smart contract content is to increase the user's pageview quota and/or the user's upvote quota by using funds and/or points from the user's reward account the first smart contract forming unit (6) uses the funds and/or points in the user's corresponding reward account to complete the agreed terms of the smart contract content.

4. The architecture according to claim 1, wherein the user incentive unit (5) also includes an upgrade module (502); when the valid thumbs up amount collected from other users reaches a predetermined threshold, the upgrade module (502) instructs the first smart contract forming unit (6) to issue a smart contract request and content to encourage the responding user, the first smart contract execution unit (7) receives and sands the smart contract to a level adjustment unit (15), the level adjustment unit (15) rises the royalty factor of the user level provisionally by rising the basic user level.

5. The architecture according to claim 1, wherein further comprising a privilege self-tuning unit (3) that allows the responding user to adjust the level of the post answer contents to be lower or higher than the user level of the responding user, and the royalty factor of the responding user is also reduced or raised to the corresponding level after the response level is reduced or raised provisionally.

6. The architecture according to claim 1, wherein further comprising a user level adjustment unit (15), the agreed terms in the smart contract content of the first smart contract forming unit (6) is to increase the user level issued by the user interface unit (2) temporarily using the money or tokens deposited in the reward account and executed by the first smart contract execution unit (7) and the user level adjustment unit (15) to adjusts the temporary user level.

7. The architecture according to claim 1, wherein the agreed terms in the smart contract content of the first smart contract forming unit (6) is to cash out all or part of the tokens from the user's reward account.

8. The architecture according to claim 1, wherein further comprising at least one affiliate linking website (9) and a charging for translation unit (8), the agreed terms in the smart contract content of the first smart contract forming unit (6) is to pay the service fee for the users by using the money or tokens deposited in the reward account and executed by the first smart contract execution unit (7) and the charging for translation unit (8).

9. The architecture according to claim 1, wherein further comprising a content component timestamp unit (10) that uses the blockchain mode to record the question contents and the answer contents presented by the social networking Q&A website basic unit (1), wherein each record of the question contents and the answer contents at least includes a timestamp.

10. The architecture according to claim 9, wherein further comprising an IP protection unit (11), the IP protection unit (11) receives a user's judicial relief request for an answer content with the timestamp recorded by the content component timestamp unit (10), and uses the crawler technique to compare the similarities extracting of the answer content with the other answer contents post on the social networking Q&A website basic unit (1), and then compares the timestamp of the answer content with that of the other answer contents to get a judgment result if at least one similarities answer has been found, the judgment result will be sent to a result feedback unit (12).

11. The architecture according to claim 10, wherein further comprising a second smart contract forming unit (13) and the second smart contract execution unit (14), if the infringing result is true, the second smart contract forming unit (13) issues a infringing result information from the result feedback unit (12), forms a smart contract content to punishment the infringing user, and the second smart contract execution unit (14) receives and sands the smart contract to a level adjustment unit (15), the level adjustment unit (15) brings down the user level of the infringing user.
